(19) United States
(12) Patent Application Publication
(10) Pub. No.: US 2020/0081530 A1
(43) Pub. Date: Mar. 12, 2020

(54) METHOD AND SYSTEM FOR REGISTERING BETWEEN AN EXTERNAL SCENE AND A VIRTUAL IMAGE

(71) Applicant: EYEWAY VISION LTD., Yehuda (IL)

(72) Inventor: Boris Greenberg, Tel-Aviv (IL)

(21) Appl. No.: 16/682,461

(22) Filed: Nov. 13, 2019

Related U.S. Application Data
(63) Continuation-in-part of application No. PCT/IL2018/050589, filed on May 29, 2018.

(30) Foreign Application Priority Data
May 29, 2017 (IL) 252582

(51) Int. Cl. G06F 3/01; G02B 27/01; G06T 19/00; G06T 7/521

(52) U.S. Cl. CPC G06F 3/013; G02B 27/0172; G02B 2027/0187; G06T 19/006; G06T 7/521; G02B 27/0179

(57) ABSTRACT

The present invention provides a technique for use in augmented reality projection for determining registration between an external scene imaged by the eye on the retina and virtual image/augmentation data. In some embodiments, the invention relates to a technique for determining registration between augmented reality projection on the retina and the external scene captured on the retina, by imaging the retina and identifying projection of the external scene thereon.

### TECHNOLOGICAL FIELD

The invention is in the field of eye projection, and more specifically relates to techniques for projecting pure augmented/virtual reality imagery onto a user's eyes.

### BACKGROUND

Head mounted or otherwise wearable image projection systems for projecting virtual and/or augmented reality onto a user's eye(s) are becoming increasingly popular. Such systems are in many cases configured as glasses mountable onto a user's head and operable for projecting images onto the user's eyes for providing virtual reality image/video projection to the user. To this end, certain of the known systems are aimed at providing pure virtual reality image projections to the user's eyes, in which light from the external scene is blocked from reaching the eye(s), while other systems are directed to provide an augmented reality experience, in which light from the external scene is allowed to pass into the eyes, while also being augmented/superposed by images/video frames projected onto the eyes by image projection systems.

### General Description

The present invention provides a technique for use in augmented reality projection for determining registration between an external scene imaged by the eye on the retina and virtual image/augmentation data. In some embodiments, the invention relates to a technique for determining registration between augmented reality projection on the retina and the external scene captured on the retina, by imaging the retina and identifying projection of the external scene thereon.

In conventional techniques, where the image perceived by each of the eyes is projected onto an image plane in front of the eyes, the image plane is typically associated with a reference frame that is either fixed with respect to a reference frame of the external scene/environment where the user is located (as is the case in typical 3D movie theaters where a real image is projected onto a fixed screen in the theater), or is fixed with respect to a reference frame associated with the user's head (as in the case of pilots' or gamers' helmets, which are designed to project augmented/virtual reality to their users). In any of these cases, the projected image is not fixed to the reference frame of the eye (i.e. line of sight of the eyeball), which results in the known problem of target-sight alignment to the projection module, and which requires specific calibrations.

The principles of technique of direct projection of images onto the eye retina are described for example in more detail in co-pending PCT patent publication No. WO 2015/132775, co-assigned to the assignee of the present application, and incorporated herein by reference. This direct projection of images directly onto the retina of the eye allows for generating images with improved depth of field on the retina, thus avoiding eye discomfort and fatigue that is a consequence of the eye's attempts to focus at mistaken distances.

The present invention relates, generally, to a registration system and methods, and to augmented reality (AR) technology for integrating or augmenting real information of an external scene such as actual or captured real-world images, with virtual information such as images of computer-generated objects. More particularly, the invention relates to a technique for registering virtual-world information to real-world information within an AR system.

AR technology allows a person to see or otherwise sense a computer-generated virtual world integrated with the real world. The “real world” is the environment that an observer can see, feel, hear, taste, or smell, using the observer's own senses. The “virtual world” is defined as a generated environment stored in a storage medium or calculated using a processor. A registration system within the AR technology registers the virtual world to the real world, to integrate virtual and real information in a manner usable by the observer.

The system of the present invention is thus configured not only to enable very accurate alignment for projected information with the real world, but also to generate an optimal and real-time occlusion map which is a significant issue for near body interaction.

The technique utilizes reflection of light from the retina to image the projection of external scene onto the retina; register input of the augmentation video/graphics relative to the image projection of the external scene onto the retina, thereby enabling to project the augmentation video onto the retina in registration with the external scene. More specifically, at the specific projected wavelength, the world information data is convoluted with the real world image data. For the rest of the spectrum, (excluding the projected wavelength), the information data of the real world is maintained in the visible spectrum since the integral of the rest of the visible spectrum has a significant amount of energy.

According to a broad aspect of the present invention, there is provided a registration system to be used with an augmented reality system comprising: a sensor configured and operable for receiving a light beam portion reflected from a retina of a user's eye and imaging the reflected light beam portion being indicative of an image of an external scene perceived by the user's eye to thereby generate a reconstructed image; and a control unit connected to the sensor and being configured and operable to receive a three dimensional image data of an external scene, compare the reconstructed image with the three dimensional image data; and register between at least one parameter of the external scene and of a virtual image relative to the eye to thereby enable to project the virtual image on the retina in registration with the external scene. In this connection, it should be understood that, as described above, the three dimensional image data of an external scene is generated by an imaging unit located above the eye of the user and is thus prone to parallax effects in reference to users' eyes. Because the camera unit cannot be positioned on the eye, a parallax (i.e. difference in the apparent position of an object viewed along two different lines of sight: the line of sight of the camera unit and the line of sight of the eye) exists. One objective of the registration system of the present invention is to adjust the projection to compensate for this parallax offset, before projection of the virtual images. Once the registration has aligned the target-sight, during projection of the images, the registration system repeats the registration process to compensate for any displacement of glasses on a user's face. To this end, the system of the present invention compares image data indicative of the external scene and image data reflected from the user's eye to determine the relative position and orientation between an imaging unit collecting image data indicative of the external scene and the eye of the user, register virtual world objects to real world objects, and integrate virtual world objects with real world objects either by displaying or projecting an image of the virtual world objects over the real world objects or by electronically combining an image of the virtual world objects with a captured image of the real world objects.

In some embodiments, the registration system of the present invention is used as a means for registering virtual information to real world information within an augmented reality (AR) system. Proper registration in an AR system enables a user to correctly view a virtual scene and be guided to properly place or otherwise interact with real objects in an augmented view. The registration process conducted by the registration system determines parameters comprising the relative position and orientation between at least one real world object or target, and the user's eye.

In some embodiments the technique of the present invention enables to provide registration of virtual information to real world information, without calibration.

In some embodiments, the registration system further comprises an image generator adapted to obtain data indicative of the virtual image, produce a plurality of light beam portions corresponding to pixels of the virtual image, and direct the light beam portions to propagate along a general optical propagation path.

In some embodiments, the registration system further comprises an eye projection optical module including a deflector which is configured and operable for deflecting the general optical propagation path of the light beam portions towards a pupil of the user's eye, thereby directly projecting the virtual image onto a retina of the eye.

In some embodiments, the registration system further comprises an imaging unit adapted to transmit light towards the external scene, collect light reflected therefrom, and process the collected light to generate a captured three dimensional image thereof.

According to another broad aspect of the present invention, there is also provided an eye projection system to be used with a user's eyes perceiving an external scene. The system comprises a sensor located in an optical path of light reflected from each user's eye and is configured and operable for receiving a light beam portion reflected from the user's retina and imaging the reflected light beam portion being indicative of an image of the external scene to thereby generate a reconstructed image of the external scene; an image generator adapted to obtain data indicative of a virtual image, produce a plurality of light beam portions corresponding to pixels of the virtual image, and direct the light beam portions to propagate along a general optical propagation path; an eye projection optical module located in the general optical propagation path comprising a deflector is configured and operable for deflecting the general optical propagation path of the light beam portions towards the user's eye, thereby directly projecting the virtual image onto a retina of the eye; wherein the general optical propagation path is deflected such that the light beam portions incident on the pupil with different pupil incidence angles are directed at different gaze directions with respect to a line of sight of the eye associated with a certain gaze direction; and, a control unit being adapted to receiving a three dimensional image data of the external scene; wherein the control unit is connected to the sensor and is configured and operable to receive data indicative of the reconstructed image, compare the data with the three dimensional image data, register between at least one parameter of the external scene and of the virtual image relative to the light of sight of the eye, to thereby enable projecting the virtual image onto the retina in registration with the external scene.

In some embodiments, the at least one parameter of the external scene and of the virtual image comprises at least one of position and orientation relative to the user's face.

In some embodiments, the sensor is integrated within the eye projection optical module.

In some embodiments, the system further comprises an imaging unit adapted to transmit light towards at least a region of interest of the external scene, collect light reflected therefrom, and process the collected light to generate a three dimensional image data thereof.

In some embodiments, the image generator comprises at least one light source configured and operable to generate at least one light beam portion at a certain wavelength range.

In some embodiments, the eye projection optical module comprises an image scanner. The scanner may be configured and operable to perform image scanning such that the reflected light beam portions, corresponding to various locations on the retina, are sequentially collected by the sensor.

In some embodiments, the system further comprises a beam splitter/combiner being adapted for transmitting light from the eye projection optical module towards the pupil of the user's eye, and reflecting the light beam portion reflected from the retina towards the sensor. The beam splitter/combiner may be configured as a notch filter adapted for transmitting one or more spectral bands towards the pupil of the user, or a broadband reflector.

In some embodiments, the sensor comprises an IR sensor configured and operable for detecting reflection of at least one IR light beam from the eye.

In some embodiments, the deflector is configured as an image scanner configured and operable to perform image scanning during which the light beam portions are deflected such that the light beam portions are incident on the pupil with various pupil incident angles corresponding to various locations on the retina.

In some embodiments, the system further comprises an eye tracker adapted to determine a gaze direction of the user's eye.

In some embodiments, the eye projection optical module comprises an adjustable focusing element for varying the divergence of the light beam portions towards the pupil of the user's eye. The adjustable focusing element is configured for adjusting the focusing properties of the registration system to perceive a sharp ‘in focus’ reconstruction of the image corresponding to the instantaneous gaze direction.

According to another broad aspect of the present invention, there is provided a method for registration between an external scene perceived by a user's eyes and a virtual image. The method comprises at least the following steps: receiving a three dimensional image data indicative of the external scene and data indicative of the virtual image; receiving a light beam portion reflected from the retina and imaging the reflected plurality of light beam portions being indicative of an image of the external scene to provide a reconstructed image; comparing the reconstructed image with the three dimensional image data; registering between at least one parameter of the external scene and of the virtual image relative to the user's eye to thereby enable projecting the virtual image on the retina in registration with the external scene; producing a plurality of light beam portions corresponding to pixels of the virtual image and directing the light beam portions to propagate along a general optical propagation path; and deflecting the general optical propagation path of the light beam portions towards a pupil of each user's eye, according to the registration.

In some embodiments, at least one parameter of the external scene and of the virtual image comprises at least one of position and orientation relative to the user's face.

In some embodiments, the method further comprises the step of transmitting light towards the external scene, collecting light reflected therefrom, and processing the collected light to generate the three dimensional image data thereof. Alternatively, the three dimensional image data can be gathered from two or more spatially distributed cameras mounted on the headset and/or from a non-fixed camera and inertial measurement unit pair that generate the three dimensional image data.

In some embodiments, the step of producing a plurality of light beam portions comprises generating at least one light beam portion at a certain wavelength range.

In some embodiments, the step of receiving a light beam portion reflected from the retina comprises performing image scanning, such that the reflected light beam portions corresponding to various locations on the retina are sequentially collected.

In some embodiments, the step of deflecting of the general optical propagation path of the light beam portions towards a pupil of a user's eye comprises performing image scanning during which the light beam portions are deflected such that the light beam portions are incident on the pupil with various pupil incident angles corresponding to various locations on the retina. The step of deflecting of the general optical propagation path of the light beam portions towards a pupil of a user's eye may additionally or alternatively comprise transmitting one or more spectral bands of the light beam portions towards the pupil of the user.

In some embodiments, the step of receiving a light beam portion reflected from the retina comprises detecting reflection of IR or a visible light beam portion.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1 is a block diagram schematically representing a partial view of some elements of the registration system according to some embodiments of the present invention;

FIG. 2A shows an image of an external scene as appearing for a user's perception (in the brain);

FIG. 2B shows an image of the same as appearing on the retina;

FIG. 2C shows an image of the retina's structure of a specific subject;

FIGS. 3A-3B schematically represent occlusion of a virtual object and the handling of such occlusion;

FIG. 4A schematically represents a schematic view of some elements of the scanning projection system according to some embodiments of the present invention in which projection of the virtual object onto the eye's retina and the perception of the user are also represented;

FIG. 4B schematically represents a schematic view of some elements of the scanning projection system according to some embodiments of the present invention;

FIGS. 5A-5C schematically show the available wavelengths of the photodiode sensor and the different detection made by the sensor;

FIG. 6 is a block diagram schematically representing the registration system according to some embodiments of the present invention;

FIG. 7 is a flow chart schematically representing the principal steps of the technique according to some embodiments of the present invention; and

FIG. 8 schematically represents another configuration of the registration system according to some embodiments of the present invention.

### DETAILED DESCRIPTION OF EMBODIMENTS

It should be understood that the optical modules/elements described below, designate functional optical elements/modules and configurations thereof which are used for implementing the invention. Accordingly, the optical elements/modules are described below in accordance with their functional operations. It should be noted that these optical elements/modules can be implemented practically by utilizing various arrangement combinations of actual optical elements. Additionally, in certain embodiments of the present invention, two or more of the functional optical modules described below may be implemented integrally in a common optical module/element, and/or a single functional optical element/module described below may be actually implemented utilizing several separate optical elements. To this end, a person of ordinary skill in the art, having knowledge of the present invention, will readily appreciate the various configurations of optical elements/modules and the various arrangements of such modules, for implementing the present invention, and the optical functions of the functional optical element/modules described below.

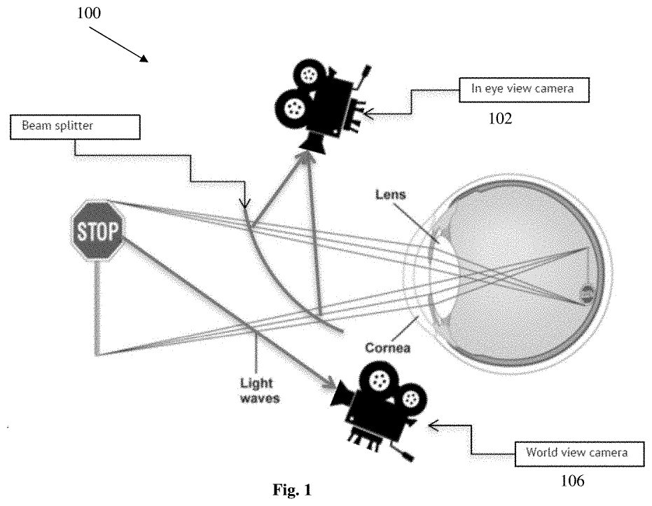

Referring to FIG. 1, there is illustrated, by way of a block diagram, a partial schematic view of a structural and functional part of a registration system 100 of the present invention. The registration system 100 is configured for registering between at least one parameter of the external scene and of a virtual image relative to the eye, to thereby enable to project the virtual image on the retina in registration with the external scene. The object registration indicates the position of the object with respect to the eye. The registration system 100 may include inter alia such main constructional parts as a sensor 102 (i.e. in eye view camera), a transparent beam splitter/combiner BSC and an imaging unit 106 (i.e. world view camera). The sensor 102 is configured and operable for receiving a light beam portion reflected from a retina of a user's eye, and imaging the reflected light beam portion being indicative of an image of an external scene perceived by the user's eye to thereby generate a reconstructed image. The imaging unit 106 is adapted to transmit light towards at least a region of interest of the external scene, collect light reflected therefrom, and process the collected light to generate a three dimensional image data thereof. The imaging unit 106 may be a camera capable of capturing images from the real world and sending these images to a control unit (not shown). The registration system 100 of the present invention provides a precise target alignment by superimposing the image in the eye with a real world image. The sensor 102 and the camera unit 106 may be synchronized to capture the images substantially concurrently. The BSC may be a curved semi-reflective mirror adapted for transmitting light from the external scene towards the pupil of the user's eye, and reflecting the light beam portion reflected from the retina towards sensor 102.

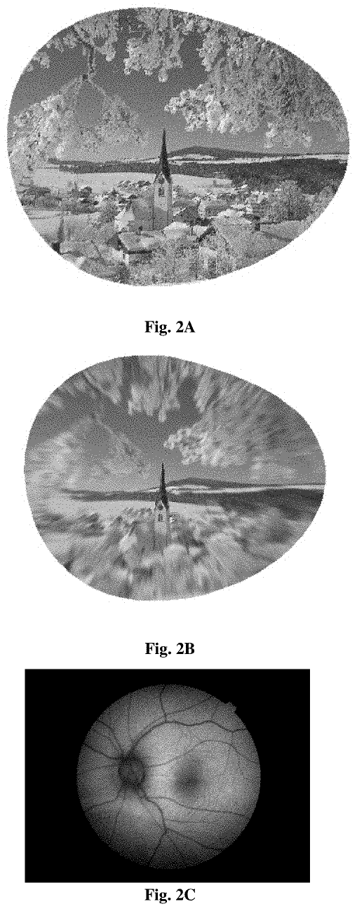

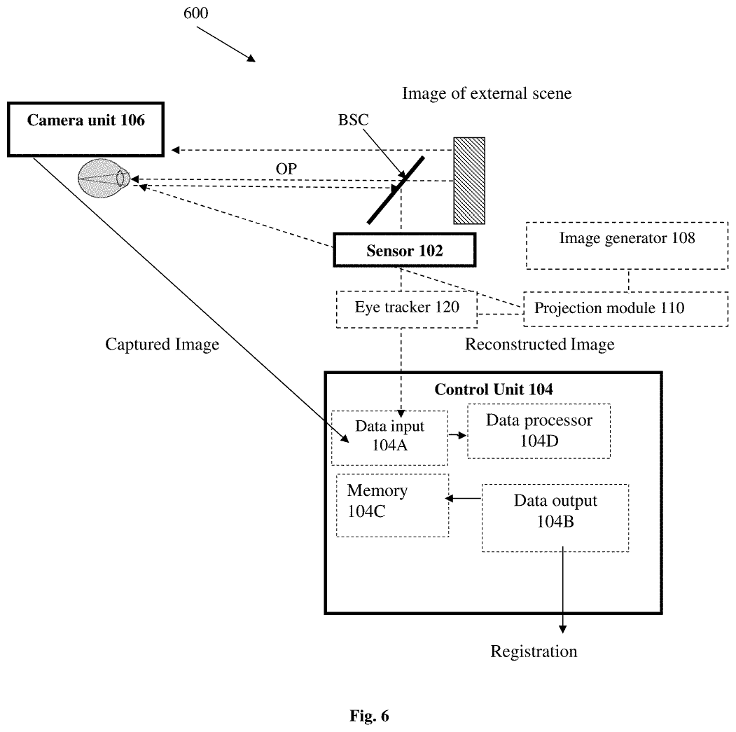

As indicated above, the image received by the sensor 102 is indicative of the external scene perceived by the eye. FIG. 2A shows an image as perceived by the subject. FIG. 2B shows the same image as appearing on the retina and therefore as captured by the sensor 102 of FIG. 1. It should be understood that generally, the eye is roughly spherical, with the cornea and lens in front, and the retina on the back inner surface. Most of the refraction required for focusing an image on the retina occurs at the air-cornea interface. The lens modifies the image focus by adjusting its focal length. This process is called accommodation. The ciliary muscles pull the lens into the proper shape. The sharpest part of the image is focused on the fovea of the retina (on the visual axis behind the lens). Most aberrations in the cornea-lens system are effectively minimized by the non-uniform index of refraction in the lens. Some chromatic aberration remains. Short waves are focused too close to the lens for the eye to accommodate the image on the retina. As clearly shown in the figure, the image contains large field/geometrical distortions since it is focused on a spherical retina, but these distortions are easily corrected in the brain in a process called constancy, as shown in FIG. 2A. FIG. 2C shows an image indicative of the retina structure of a specific subject. The image received by the sensor 102 of FIG. 1 is indicative of the retina's structure (as illustrated in FIG. 2C) superposed with the image of the external scene, and contains the large field/geometrical distortions generated by the eye, since the image is focused on a spherical retina (as illustrated in FIG. 2A). The registration system of the present invention is configured for compensating for such geometrical distortions, as well as for filtering out data indicative of the retina's structure from the image received by the sensor, as will be described further below with respect to FIG. 6.

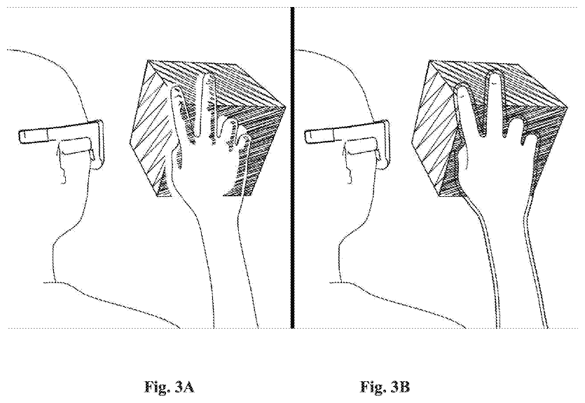

Reference is made to FIGS. 3A-3B representing an occlusion/obtrusion issue frequently occurring during projection of virtual images. In this specific and non-limiting example, the hand of the user is moved to the field of view of the user and therefore occludes a part of the cube, being, in this example, the virtual object. Occlusion refers to a situation where part of a scene is invisible because something is in front of it. In the context of augmented reality, this means that something is between the camera and the 3D location of virtual elements. As shown in FIG. 3B, where such occlusions occur, the control unit generates a mask cutting the exact shape of the occluding object which is subtracted from a generated image and only the non-occluded section(s) of the image is/are projected. Therefore the present invention generates an optimal and real-time occlusion map implemented in the form of a mask. The mask may be formed by applying translation and rotation mathematical operation to the 3D scene as it goes from the camera view point to the eye view point. Then the real world 3D map may be hierarchically sliced together with the virtual objects to build a tree of virtual objects specifying which object is in front of which from the user stand point. This technique is similar to computer rendering process utilizing textures or ray tracing.

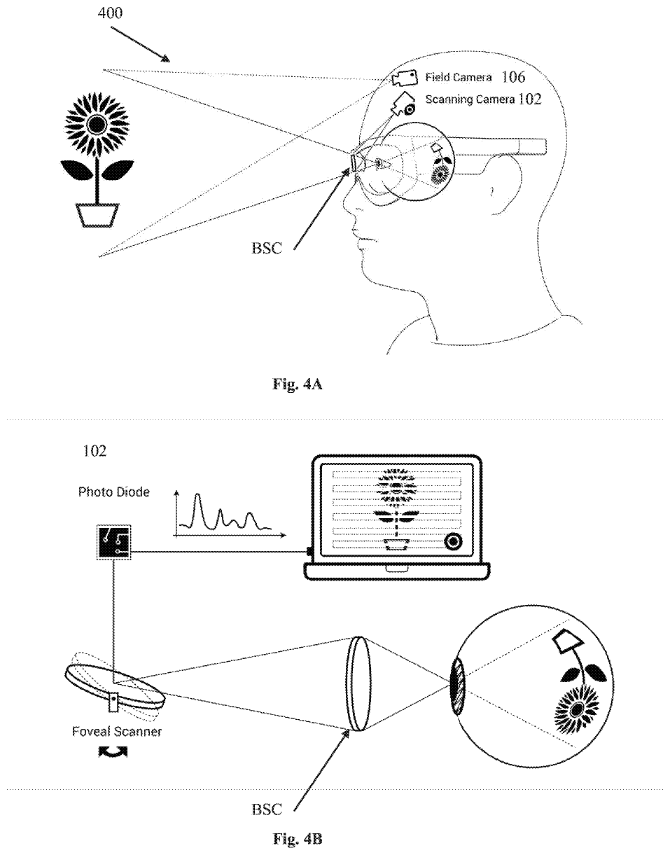

In this connection, it should be understood that one of the challenges of any pure/augmented virtual reality system is to align virtual data with the environment. The line of sight of the camera unit located in the glasses frame slightly above the eyes of the user (as shown in FIG. 4A below) should be exactly correlated with the line of sight of the eyes. To provide a real perception experience to the user, the line of sight of the camera unit should be perfectly coordinated with the line of sight of the eye of the user. Transformation between the camera coordinates and the world coordinates consists of a rotation vector and a translation vector. Usually, matching of the rotation vectors is quite simple, however there is a need in providing an exact translation transformation between the camera coordinates and the world coordinates. Therefore, to avoid occlusion perception, the position of the mask occluding the occluding object should be translated according to the correlation between the line of sight of the camera unit and the line of sight of the eye of the user.

It should also be noted that the needed registration accuracy of a projecting system depends on the environment and distance of the objects being viewed: lower accuracy registration may be acceptable for objects far away in large scale environments where parallax offsets are less noticeable, while accurate augmentation of nearby objects is harder. Correct occlusion between real and virtual objects should occur and the virtual environment should be thus superimposed exactly on the real environment because both environments are visible. Disagreement in matching and stitching locations and size between real and virtual objects is likely to occur between the world coordinates of the real environment and those of the virtual environment. This disagreement directly causes displacement of locations where virtual objects are superimposed. An appropriate registration between the virtual object and the real world must thus be made so that the virtual environment is superimposed properly. Sensitivity of the eye at the fovea is about 1/60°, while at the periphery sensitivity is about ⅙°. Therefore the user is very sensitive to occlusion appearing in the fovea region.

Reference is made to FIG. 4A representing a simplified schematic illustrating of the registration system 400 of the present invention. The registration system 400 of the present invention, typically configured to be head mounted, may be used with one or two eye display units for providing a user with display data. The system is generally configured to provide a virtual or augmented reality experience to the user by displaying image data with a relatively large field of view, and is configured to incorporate actual visual data of a region in front of the user (actual scene) in the display data, substantially in real time. As described in FIG. 1, the registration system 400 includes inter alia such main constructional parts as a sensor 102 (i.e. scanning camera) receiving a light beam portion reflected from a retina of a user's eye and imaging the reflected light beam portion being indicative of an image of an external scene (e.g. a flower in this specific and non-limiting example) perceived by the user's eye, an imaging unit 106 (i.e. field camera) collecting light reflected from an external scene, and generating a three dimensional image data thereof, both located above the user's eyes, and a transparent beam splitter/combiner BSC adapted for transmitting light from the external scene towards the pupil of the user's eye and reflecting a light beam portion reflected from the retina towards sensor 102. The sensor 102 is adapted to perform image scanning such as a raster scan on various locations of the retina, such that the reflected light beam portions corresponding to various locations on the retina are sequentially collected by the sensor 102.

Reference is made to FIG. 4B representing a partial view of a section of the registration system of the present invention. The light reflected from the eye is collected by the BSC and is transmitted to an image scanner (e.g. foveal scanner) being one or more fast scanning mirrors operable to perform two dimensional image scanning such as a raster scan, and being configured for receiving a light beam reflected from the eye at various locations of the retina (e.g. by rotating the mirrors) corresponding to the pixels in the image, and transmitting the light beams of the various locations of the retina toward sensor 102 (e.g. a photodiode array). The scanning/raster-scanning mirror(s) may be implemented utilizing any suitable technique, such as Micro Electro Mechanical System (MEMS) mirrors mechanically coupled to suitable actuators, such as Piezo-electrical actuators or other types of actuators, enabling the mirrors to perform an image/raster scan of the light beam across a range of locations on the retina. In this connection, it should be understood that although in the figure, for clarity only, a single scanning mirror (e.g. fast scanning mirror) is illustrated (e.g. being gimbaled for rotation in two dimensions/axes), in other embodiments of the present invention two or more mirrors may be used to collect the light beam in the two dimensional image. The sensor 102 may be a photodiode array collecting, at each pixel, a different part of the external scene. The sensor 102 is rastered across the desired field of view using the image scanner to construct a 2-D image over time. To this end, the sensor 102 has a short integration time and can utilize high sensitivity elements such as but not limiting to an avalanche photodiode. The dashed line represented in the image screen outputted by the sensor 102 is the trajectory of the scanned image.

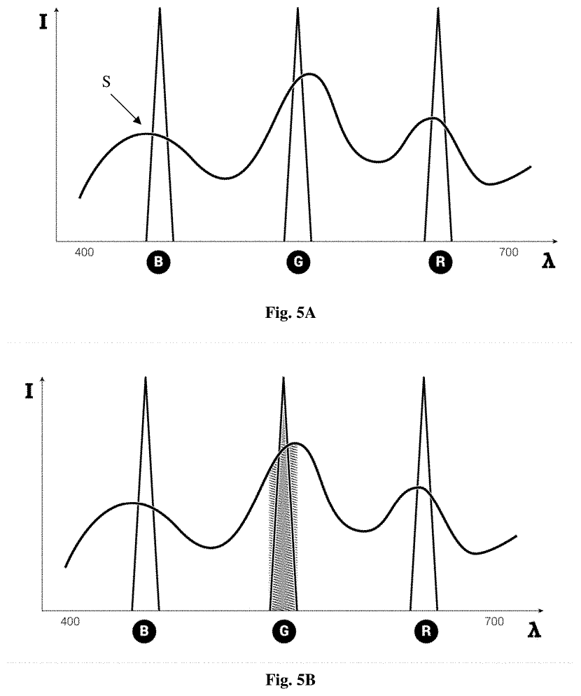

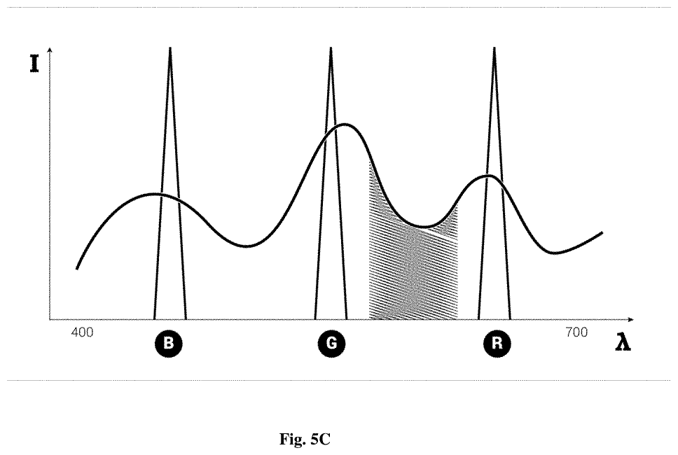

Reference is made to 5A-5C representing the range of wavelengths covered by the sensor 102, being for example a silicon-based or Gallium Nitride solid stated direct emitting photodiode. As shown in the figures, the photodiode has a 3-channel (RGB) photodiode sensitive to the blue (λp=460 nm), green (λp=520 nm) and red (λp=640 nm) regions of the spectrum. Curve S represents the optical detection of the external scene perceived by the eye generated by the sensor 102 and the R,G, B peaks are the detection of the RGB projection of the virtual image. It should be noted that the method of registration of the present invention may optionally comprise a calibration stage of the camera unit 106 in which a pattern is projected on the retina of the user. The user is then requested to identify some points on the pattern to enable to the control unit 104 to identify distortion, aberrations and spreading specific for each user. FIG. 5B shows detection of a calibration pattern by the sensor 102 usually performed in the green range. FIG. 5C shows that a certain spectral region of interest is selected and the sum (integral) of the intensities of the received radiation for this selected region is determined for identifying projection of the scene on the retina.

Referring to FIG. 6, there is illustrated, by way of a block diagram, a partial schematic view of a structural and functional part of a registration system 600 of the present invention. The registration system 600 may be used with an external augmented reality system or may be a part of an augmented reality system. The registration system 600 includes such main constructional parts as a sensor 102 and a control unit 104.

The control unit 104 utilizes input image data that corresponds to line of sight as expected by the user. The control unit 104 is configured generally as a computing/electronic utility including inter alia such utilities as data input and output utilities 104A, 104B, memory 104C, and data processor module 104D. The control unit 104 is connected to sensor 102 by wires or wireless. The control unit 104 is configured and operable to receive a three dimensional image data of an external scene, compare the reconstructed image of the sensor with the three dimensional image data, and register between at least one parameter of the external scene and of a virtual image relative to the eye, to thereby enable to project the virtual image on the retina in registration with the external scene. The parameters of the external scene and of the virtual image may be position (e.g. translation matrix) and/or orientation (e.g. rotation matrix).

The data indicative of the image captured by the sensor 102 is transmitted to the control unit 104 and the data processor 104D is configured for filter out (e.g. de-convoluting) from the image, the image data indicative of the retina's structure. This can be proceed in several ways: in a pre-calibration stage an image data indicative of the retina's structure is stored in memory 104C such as illustrated in FIG. 2C and the data processor 104D filters out the pre-calibrated image data indicative of the retina's structure from the image received by the sensor 102. Alternatively, the data processor 104D analyses the image data indicative of the retina's structure to estimate reflection properties of the retina's structure i.e. differentiate between geometrical regions of different brightness. As shown in FIG. 2C, the part of the eye responsible for sharp central vision, called fovea centralis, is located in the center of the retina. The fovea is surrounded by the parafovea belt, and the perifovea outer region. The parafovea belt, and the perifovea outer region are regions with much lower brightness than the fovea, since more blood vessels are present in these regions. Therefore the structure of the retina may be estimated by differentiating between regions of different brightness. Alternatively, the structure of the retina may be estimated by locally identifying changes in brightness in different regions of the image. A scanning of the image may be performed by the control unit 104 to identify regions of high reflectivity/brightness. Generally, as mentioned above, regions of high reflectivity are indicative of regions of the retina near the fovea, while regions of low reflectivity are indicative of regions of the retina around the fovea. It should be understood that the reconstructed image corresponds to the light reflected from the eye at a specific visual angle/direction. In this regard, it should be noted that the gaze direction of the eye may change during capturing of the reflected light and/or saccadic movements of the eye may appear. In these cases the control unit 104 analyses the changes in the image and filters out these changes, to retain only the stable and fixed image data. Therefore, the control unit 104 is configured and operable to “flatten” the image of the curved shape of the eye by filtering out the image data corresponding to the structure of the retina and by selecting regions of the image of high brightness.

Optionally, the registration system may comprise an eye projection optical module configured for projecting images directly on a retina of an eye. The eye projection optical module may be for example a part of augmented or virtual reality glasses (spectacles) and may include two eye projection systems. For clarity, only one eye projection optical module is specifically shown in the figures. It should be noted that although, in the figure, only one registration system is depicted, such systems may be furnished in the eye glass for projecting images on each of the eyes, separately. In such cases the control unit 104 may also be used for operation of the image projection modules 110. Also, the systems may be operated to project stereoscopic images/video to the user's eyes to produce a 3D illusion. In some embodiments, the system comprises an eye tracker 120 adapted to determine a gaze direction of the user's eye. Eye tracker 120 may be an orientation sensor mounted on the registration system 100 to keep track of the position of the user's head. Eye tracker 120 does an angular tracking in three degrees of freedom (roll, pitch and yaw). Eye tracker 120 may be configured and operable in accordance with any suitable technique for determining a line of sight/gaze direction to which the eye is directed. There are several such known in the art techniques, which can be incorporated in or used in conjunction with the system 100 of the present invention. Such techniques are disclosed for example in international patent application publication WO 2013/117999, U.S. Pat. Nos. 7,542,210, and 6,943,754.

Optionally, the registration system 600 may comprise an image generator 108 adapted to obtain data indicative of the virtual image, produce a plurality of light beam portions corresponding to pixels of the virtual image, and direct the light beam portions to propagate along a general optical propagation path. The beam splitter/combiner BSC of FIG. 1 is adapted in this configuration also for transmitting light from the eye projection optical module 110 towards the pupil of the user's eye, in addition to reflecting the light beam portion reflected from the retina towards sensor 102 and transmitting light from the external scene towards the pupil of the user's eye. Typically, collected image data is transmitted to control unit 104 for processing and generating display data, which is provided to the user via the image generator 108. The virtual image or images generated by the image generator 108 may be of two or higher dimensions and may be depth images, color images, medical images, silhouette images, or any other type of digital image. The virtual image(s) may comprise single images or sequences of images, such as from a video camera or depth camera. In some examples, the input virtual images comprise stereo images from either a stereo camera or from multiple cameras at different viewpoints. A silhouette image is a two dimensional binary image identifying foreground and background regions of a depth, and/or color RGB image captured by an imaging sensor.

In some embodiments, the data processor 104D may provide measurements of the camera unit's orientation, either directly or determined from measured distances of at least three points in the environment and captured in the image. Pairs of corresponding points between the reconstructed image and 3D captured image (depth maps or estimated depth maps) are computed. A pair of corresponding points is a point from one depth map and a point from another depth map, where those points are estimated to have arisen from the same real world point in a scene. The term “point” is used herein to refer to a coordinate in the point cloud, or a group or patch of neighboring coordinates. Such correspondence may be problematic due to the overly large number of possible combinations of points. Shapes such as lines, edges, corners or the like may be identified in each image, and then these shapes are matched between the pairs of images.

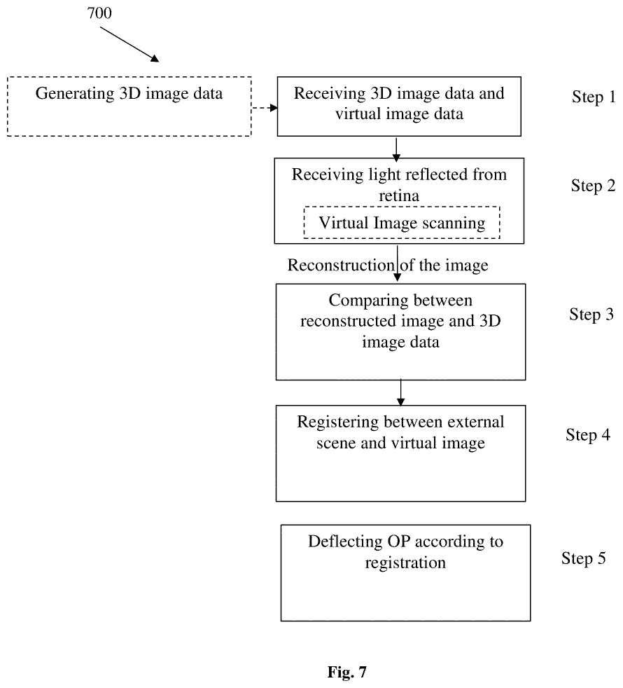

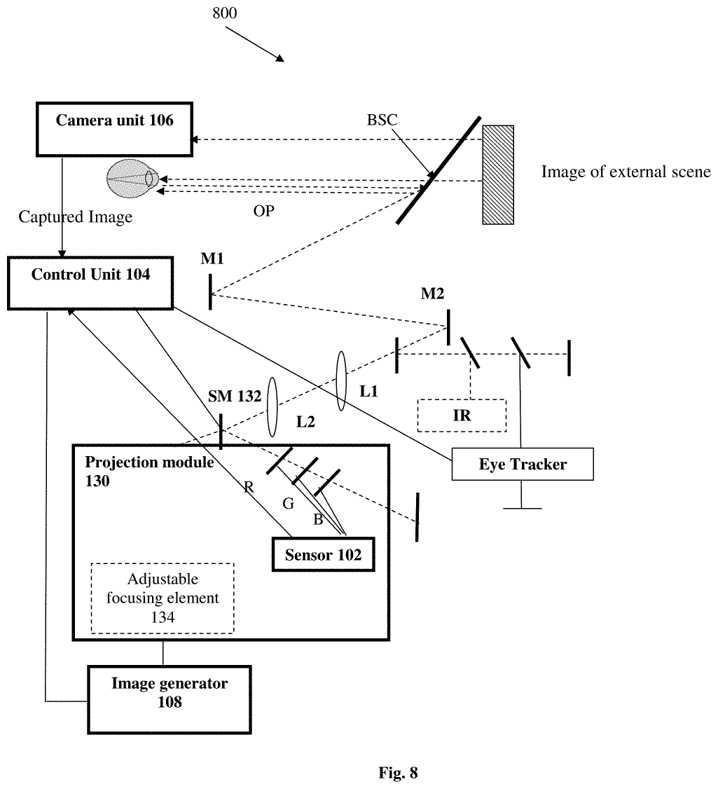

Reference is made to FIG. 7 showing a flow chart 700 of simplified different steps used in the technique of registration between an external scene perceived by user's eyes and a virtual image of the present invention. First of all, the distance between the camera and the eye of a subject is measured/provided to the control unit. In step 1, a three dimensional image data (one or multiple sequence of images) indicative of the external scene at a specific time period T and data indicative of the virtual image, is received. This three dimensional image data may be captured by an imaging unit positioned above the user's eye. In step 2, a plurality of reflected light beam portions being indicative of an image of the external scene at various locations of the retina are sequentially scanned and captured by a photodiode and integrated over time to provide a reconstructed image. The photodiode may be attached to a coordinate measurement device that tracks its position and orientation with a high degree of accuracy. The scans are then integrated into a single image.

In step 3, the reconstructed image is compared with the three dimensional image data. As described above, a region of interest/an object of interest in the reconstructed image is identified in which a sufficient brightness appears and the geometrical distortions are reduced. A correlation is performed between the two images to identify a region having a higher peak of correlation. This region is then selected to determine the registration between the virtual image and the image of the external scene. The input data comprises the optical axis of the camera, the eye gaze direction, and the optical axis of the sensor and the two images. A collineation warping function has to be found that registers at least part of the reconstructed image and the corresponding position in the captured 3D image. This function provides a translation vector correlating between the two images. As described above, the 3D camera captures a set of points in the point cloud which are computed to be translated to the world map. It should be noted that the point cloud can be reliably generated by using any technique known in the art. Among other techniques, this can be done in an iterative minimization process where a first set of points in the reconstructed image is compared with a computed set of points in the captured 3D image and the computed set of points in the captured 3D image used for the comparison varies at each iteration. In order to address the problem of matching points between two images of a stereo pair, several algorithms have been proposed. These algorithms can be grouped into those producing sparse output, and those giving a dense result, while the latter can be classified as local (area-based) and global (energy based). Stereo matching techniques may include local methods such as block matching, gradient-based optimization or feature matching, and/or global methods such as dynamic programming, intrinsic curves, graph cuts, non-linear diffusion, belief propagation, or correspondence-less methods. A Block Matching algorithm may also be used for locating matching macroblocks in a sequence of digital video frames for the purpose of motion estimation. The Block Matching methods may include normalized Cross-Correlation (NCC), Sum of Squared Differences (SSD), Normalized SSD, Sum of Absolute Differences (SAD), Rank or Census. The underlying supposition behind motion estimation is that the patterns corresponding to objects and background in a frame of video sequence move within the frame to form corresponding objects on the subsequent frame. This can be used to discover temporal redundancy in the video sequence, increasing the effectiveness of inter-frame video compression by defining the contents of a macroblock by reference to the contents of a known macroblock which is minimally different. The registration process provides an angle at which the image of the imaging unit should be normalized to find the object on the external scene. For example, the ratio of the angular difference and/or of the lateral difference between the imaging system and the projection system may be provided. The comparison step comprises a shift affinity process using for example an affine translational transformation matrix or quaternion methods. However, the shift of the user's eye with respect to the sensor 102 and to the imaging unit 106 should be taken into account to obtain more accurate registration. To this end, the epipolar calculation method may be used as described for example in Multiple View Geometry in Computer Vision, R. Hartley and A. Zisserman, Cambridge University Press, 2000. Such epipolar geometry provides a projective geometry between the two views.

In step 4 at least one parameter of the external scene and the virtual image is registered relative to the user's eye to thereby enable projecting the virtual image on the retina in registration with the external scene. The control unit may correlate the 2D segmented image features with the sparse 3D points to derive object structures and one or more properties on the object using 2D/3D data fusion by using correlation functions.

In step 5 a plurality of light beam portions corresponding to pixels of the virtual image are produced, these light beam portions being directed to propagate along a general optical propagation path, and the general optical propagation path of the light beam portions is deflected towards a pupil of each user's eye, according to the registration.

Reference is made to FIG. 8 showing another configuration of the present invention in which the eye projection system is a scanning projection system described in co-pending PCT application number No. WO17037708 co-assigned to the assignee of the present application, and incorporated herein by reference. In this connection, it should be noted that for certain embodiments of the present invention there may be a significant advantage in utilizing a scanning projection system. In this case, the sensor 102 may be integrated within the eye projecting system. Utilizing such a scanning projection system for compact applications, such as for eye glass applications, may provide for projecting images on the retina with better image quality than those which can be achieved when area projection systems are used (e.g. such as those disclosed in FIG. 6). To this end, scanning projection systems may be more compact than corresponding area projection systems. Also utilizing a scanning projection system, in which the image is projected to the eye by utilizing a laser beam for projecting a pixel at a time, provides no crosstalk between adjacent pixels. Additionally, the pixel size, namely the width of the light beam portion associated with each specific pixel projection, may be substantially wider (typically by one or more orders of magnitude) than what is achievable when using the aerial image projection technique in compact systems. Accordingly, optical modules of the eye projection optical module 130 may be configured with lower numerical apertures and may thus be associated with lower optical aberrations and provide high quality image relay to the eye with good modulation transfer function (MTF). This facilitates use of a compact image projection system for projecting images with improved dynamic range, high image contrast, and high resolution and brightness on the eye retina. Additionally, utilizing scanning projections in compact applications may also reduce and/or entirely eliminate diffraction artifacts which may be produced by compact aerial projection systems due to significantly smaller pixel sizes in the latter being of deteriorated quality.

Therefore the registration system 600 of the present invention has an F-number sufficiently large to obtain a clear image from sensor 102 and reduce the geometrical field distortion of the eye described above. The distortions of the image reflected by the eye and collected by the sensor 102 may be reduced by placing a field stop at the lens aperture of the sensor 102 to limit the system's field of view and collect a smaller portion of the light beams.

It should be noted that when operating in image scanning mode, the image pixels are projected sequentially. For example, the scanning may be performed at a high frequency (10 ns for each pixel) such that the power of the light captured by the sensor is about 3 mWatt. To amplify the power of detection, the sensor 102 may be configured as an avalanche photodiode for detecting reflected light from the eye. The high sensitivity of the avalanche photodiode enables to generate a reconstructed image of at least a portion of the external scene. An amplifier may also be placed at the output of the sensor 102 to increase the received signal.

The eye projection system 800 is adapted to obtain data indicative of an image to be projected on the eye, and to produce a plurality of light beam portions corresponding to pixels of the image. The eye projection system 800 includes a beam splitter combiner surface BSC adapted for transmitting external light from a scene towards the user's eye, transmitting reflected light from the eye towards sensor 102 and reflecting light from the eye projection module 130 towards the user's eye. This may be proceeded concurrently by using different methods for wavelength filtering. For example, a portion of the BSC may be coated with a special coating material (e.g. thin film etalon) adapted for filtering out light beams of different wavelengths such that the light reflected from the eye projection module 130 towards the user's eye and the external light from a scene towards the user's eye, may be separated. The BSC is then displaced to collect, alternatively, the reflected light and the external light. In another example, the BSC may comprise liquid crystal tunable filters (LCTFs) electronically controlling liquid crystal (LC) elements or an Acousto-Optic Tunable Filter, both being adapted to transmit a selectable wavelength of light, and exclude others. For example, the selected wavelengths may be 540 nm and 532 nm. Alternatively, one may proceed by controlling the timing of the camera unit 106 and the eye projection module 130 with a time delay, such that acquisition of the light reflected from the eye projection module 130 towards the user's eye and the acquisition of external light from a scene towards the user's eye, are timely separated.

In this specific and non-limiting example, the light reflected from the eye is transmitted from the BSC towards the projection module 130 via two mirrors M1 and M2 referred to respectively as saccade, and as pupil mirrors configured for following the gaze direction of the eye. The gaze direction of the eye is then detected by an eye tracker. Additionally or alternatively, the system 700 may include an infra-red (IR) light emitter 21 placed on the eye glasses bridge and adapted for directing an IR light beam to the eye, and the sensor 102, being an IR sensor, located on the eye glasses frame/arm is adapted for detecting the reflection of the IR light beam from the eye (e.g. from the pupil and/or cornea and/or retina thereof). The control unit 104 is adapted for processing the pattern of the reflected IR light beam to determine the gaze direction of the eye. In this specific and non-limiting example, the sensor 102 which may be integrated in the eye projection system 130 or which may be an external module, is located on the frame and/or handle of the eye glasses, as illustrated in FIG. 4A. The sensor 102 receives the light reflected from the user's eye via the BSC, the saccade and pupil adjustable mirrors M1 and M2, and spaced-apart relay lenses L1 and L2 defining an afocal system. One or more scanning mirrors SM 132 are placed in the optical path between the light reflected from the eye and the sensor 102 to perform scanning/raster-scanning of the reflected light beam (e.g. by rotating the mirrors), during which each scan angle corresponds to another location of the image on the retina. The scanning/raster-scanning mirror(s) SM 132 may be implemented utilizing any suitable technique, for example electro optical deflectors and/or using mirrors, such as Micro Electro Mechanical System (MEMS) mirrors mechanically coupled to suitable actuators, such as Piezo-electrical actuators or other types of actuators, enabling the mirrors to perform an image/raster scan of the reflected light beam across a range of scanning angles. In this connection, it should be understood that although, in the figure, for clarity only, a single scanning mirror (e.g. fast scanning mirror) SM 132 is illustrated (e.g. being gimbaled for rotation in two dimensions/axes), in other embodiments of the present invention two or more mirrors/deflectors may be used to deflect the reflected light beam in the two dimensional image scanning angles. The sensor 102 images this scanned reflected light from the retina being indicative of an image of the external scene, and generates a reconstructed image of the external scene as viewed by the user. As described above, the image of the retina's structure is filtered out from this image to obtain only an image indicative of the external scene. When the sensor 102 is integrated in the eye projection module 130 the capturing of the image reflected from the eye and the projection of the virtual image proceeds concurrently. In the embodiment illustrated in FIG. 8, the sensor 102 comprises three photodiodes, R, G and B, which may be photodiodes sensitive to Red, Green, and Blue wavelengths range. In turn, the beam splitter combiner surface of the eye glass lens may configured as a notch filter or notch filter, and may be positioned before the sensor 102, the notch filter being adapted for reflecting the one or more narrow spectral bands towards the user's eye, while transmitting light arriving from the scene and being outside of these narrow spectral bands. In this way, the reflected light of a specific wavelength may be captured by the sensor.

The optical path for detecting the light reflected from the eye comprising the above-described optical elements such as BSC, mirrors M1 and M2, relay lenses L1 and L2 and scanning mirror 132 is also used for projecting the virtual image in registration with the external scene towards the user's eye. The optical configuration of the eye projecting system 800 is arranged such that the light beam portions incident on the pupil with different pupil incidence angles are directed at different gaze directions with respect to a line of sight of the eye associated with a certain gaze direction. This unique configuration enables to use the same system for imaging light reflected from the eye, as well as projecting a virtual image towards the retina. The same angular scale is used for both operations. Registration may provide the ratio of the angular and/or lateral difference between the imaging system and the projection system. The optical distortions of the system are then related to the distortions of the optical system, and not of the eye. The SM 132 is also used as a gaze tracking deflector configured and operable for directly projecting the virtual image onto a retina of the eye. Eye projection optical module 130 is thus adapted for receiving light beams (or portions thereof) outputted from the image generator 108 with the projection angles, and directs them such that they are incident on the eye pupil with the corresponding pupil incidence angles, such that the image pixels are directly projected onto the retina in their proper location. The image generator 108 is adapted to obtain data indicative of a virtual image, produce a plurality of light beam portions corresponding to pixels of the virtual image, and to direct the light beam portions to propagate along a general optical propagation path OP. The gaze tracking deflector 132 includes the one or more scanning mirrors SM which perform scanning/raster-scanning of the light beam (e.g. by rotating the mirrors), during which the light beam is deflected to propagate over a range of image projection angles α_{sCn}, where, typically, each projection angle corresponds to a pixel of an image projected on the retina. The scanning/raster-scanning mirror(s)/deflectors SM deflect a light beam from projection module 130 to perform an image/raster scan of the light beam across a range of projection angles α_{scn}. In this connection, it should be understood that although in the figure, for clarity only, a single scanning mirror (e.g. fast scanning mirror) SM is illustrated (e.g. being gimbaled for rotation in two dimensions/axes), in other embodiments of the present invention, two or more mirrors/deflectors may be used to deflect the light beam in the two dimensional image projection angles α_{scn} (i.e. {α^{X}_{scn} α^{Y}_{scn}}). The image generator 108 may comprise inter alia an image scanner including an adjustable optical deflector (e.g. one or more fast scanning mirrors operable to perform two dimensional image scanning such as a raster scan). The image scanner is configured and operable to receive an input light beam and deflect it so as to adjust an angle of incidence of the light beam with the pupil of the user's eye. To this end, the adjustable optical deflector of the image scanner performs image scanning, such as a raster scan, during which the light beam is deflected such that it is incident on the pupil with various pupil incident angles αᵢₙ corresponding to various locations on a retina of the eye. In turn, the intensity, and possibly also the spectral content of the light beam, is modulated in accordance with the image to be projected onto the retina, such that respective pixels of the image are projected onto the various locations of the retina during image scanning. In other words, the pupil incident angles αᵢₙ correspond to the pixels in the image, and cause these pixels to directly project onto respective locations on the retina. As indicated above, one of the prominent deficiencies of conventional techniques is that the projected image captured by the eye is not fixed to the eye coordinates (reference frame), but to another reference frame, be it the reference frame of the scene external to the eye, or the reference frame of the user's head. Accordingly, when the gaze direction of the eye changes, the location of projection of the image on the eye retina changes accordingly. This is because the actual pupil incidence angle αᵢₙ depends on gaze direction. The eye projection optical module 130 comprises a gaze tracking deflector located in front of the corresponding eye of the user and is configured to direct light arriving from at least a region of interest of an external scene located in front of the user, and to direct light arriving from the at least one image generator 108 to the user's eye. In embodiments in which colorful image projection on the retina is sought, the image generator 108 comprises a light module and may include one or more light sources configured and operable to generate at least one light beam portion at a certain wavelength range (typically three Red, Green and Blue laser sources).

It should be noted that the eye is continuously looking for a focal point on the external scene, which causes fatigue to the user. To solve this problem, the eye projection optical module 130 may comprise an adjustable focusing element 134 for varying the divergence of the light beam portions towards the pupil of the user's eye. The variation of divergence is selected according to the registration value. For example, this can be implemented by simultaneously comparing several factors such as 3D map of the environment, eye gaze convergence and eye accommodation as for example described in international application number PCT/IL2018/050578 assigned to the same assignee of the present invention. The system accurately compares gaze fixation point with the environment 3D map and thus assumes the accommodation distance and corrects divergence of light required for this distance.

The relay lenses L1 and L2 are arranged in cascading order along the optical path to direct back image projections from the projection module and project them in combination (simultaneously or not) into the user's eye. More specifically, the relay lenses L1 and L2 are spaced apart from one another along the optical path of the light propagating from the image scanner SM to the pupil by an optical distance that substantially equals a sum of the first and second focal lengths. The relay lenses L1 and L2 are thus configured as an angular beam relay module for receiving the light beam from the image scanner SM propagating therefrom with a certain output image projection angle α_{scn} with respect to the optical axis, and relaying the light beam to be incident on the pupil with the corresponding pupil incident angle αᵢₙ. The angular relay optics provides that the angle of a light beam incident on the pupil, corresponds to the output angle at which the light beam emanated from the image projection system, and in turn it also corresponds to the respective pixel of the image. Examples of configurations and methods of operation of such optical modules including such relays which are configured and operable for direct projection of images onto the eye retina, and which may be incorporated in the optical module of the present invention, are described for example in PCT patent publication No. WO 2015/132775 and in IL patent application No. 241033, both co-assigned to the assignee of the present patent application and incorporated herein by reference.

The control unit 104 may be implemented analogically, utilizing suitable analogue circuits, or digitally, by utilizing suitable processor(s) and memory/storage module(s) carrying suitable soft-/hard-coded computer readable/executable instructions for controlling the operations of the SM 132 and for controlling operation of the image generator 108. To this end, the control unit 104 is adapted to receive data indicative of an image to be projected onto a retina of the eye from image generator 108, and data indicative of a gaze direction β of the eye, for example by the eye tracker, three dimensional image data of the external scene by the camera unit 106 and data indicative of the reconstructed image from sensor 102. The acquisition (time and rate) of the data of the control unit should be synchronized with the sensor 102, with the camera unit 106 and with the scanning mirror, to collect all the image data. The control unit 104 compares the data indicative of the reconstructed image from sensor 102 with the three dimensional image data of the camera unit 106, registering between at least one parameter of the external scene and of the virtual image relative to the light of sight of the eye. The control unit 104 controls the eye projection optical module 130 to thereby enable pixels of the virtual image to be projected onto corresponding locations on the retina in registration with the external scene by carrying out the operations of method 700 in the following, for projecting each pixel of the image.

1. An eye projection system to be used with a user's eyes perceiving an external scene, the eye projection system comprising:
a sensor located in an optical path of light reflected from each of the user's eyes and configured and operable for receiving a light beam portion reflected from the user's retina and imaging the reflected light beam portion being indicative of an image of the external scene to thereby generate a reconstructed image of the external scene;
an image generator adapted to obtain data indicative of a virtual image, produce a plurality of light beam portions corresponding to pixels of said virtual image and direct said light beam portions to propagate along a general optical propagation path;
an eye projection optical module located in said general optical propagation path comprises a deflector which is configured and operable for deflecting the general optical propagation path of the light beam portions towards the user's eye, thereby directly projecting said virtual image onto a retina of the eye; wherein said general optical propagation path is deflected such that the light beam portions incident on a pupil with different pupil incidence angles are directed at different gaze directions with respect to a line of sight of the eye associated with a certain gaze direction; and
a control unit being adapted to receive a three dimensional image data of the external scene; wherein said control unit is connected to said sensor and is configured and operable to receive data indicative of said reconstructed image, compare said data with said three dimensional image data, register between at least one parameter of the external scene and of said virtual image relative to the line of sight of the eye to thereby enable projecting said virtual image onto the retina in registration with the external scene.

2. The eye projection system of claim 1, wherein said at least one parameter of the external scene and of said virtual image comprises at least one of position or orientation.

3. The eye projection system of claim 1, wherein said sensor is integrated within said eye projection optical module.

4. The eye projection system of claim 1, further comprising at least one of an imaging unit adapted to transmit light towards at least a region of interest of the external scene, collect light reflected therefrom, and process the collected light to generate a three dimensional image data thereof, or a beam splitter/combiner being adapted for transmitting light from the eye projection optical module towards the pupil of the user's eye, and reflecting the light beam portion reflected from the retina towards said sensor, or an eye tracker adapted to determine a gaze direction of the user's eye.

5. The eye projection system of claim 1, wherein said image generator comprises at least one light source configured and operable to generate at least one light beam portion at a certain wavelength range.

6. The eye projection system of claim 1, wherein said eye projection optical module comprises an image scanner; said image scanner being configured and operable to perform image scanning such that the reflected light beam portions, corresponding to various locations on the retina, are sequentially collected by the sensor.

7. The eye projection system of claim 4, wherein said beam splitter/combiner is configured as a notch or band pass filter adapted for transmitting one or more spectral bands towards the pupil of the user.

8. The eye projection system of claim 1, wherein said sensor comprises an infrared (IR) sensor configured and operable for detecting reflection of at least one IR light beam from the eye.

9. The eye projection system of claim 1, wherein said deflector is configured as an image scanner configured and operable to perform image scanning during which the light beam portions are deflected such that the light beam portions are incident on the pupil with various pupil incident angles corresponding to various locations on the retina.

10. The eye projection system of claim 1, wherein said eye projection optical module comprises an adjustable focusing element for varying the divergence of the light beam portions towards the pupil of the user's eye.

11. A method for registration between an external scene perceived by a user's eyes and a virtual image, the method comprising:
receiving a three dimensional image data indicative of the external scene and data indicative of the virtual image;
receiving a light beam portion reflected from the retina and imaging the reflected plurality of light beam portions being indicative of an image of the external scene to provide a reconstructed image;
comparing said reconstructed image with said three dimensional image data;
registering between at least one parameter of the external scene and of said virtual image relative to the user's eye to thereby enable projecting said virtual image onto the retina in registration with the external scene;
producing a plurality of light beam portions corresponding to pixels of said virtual image and directing said light beam portions to propagate along a general optical propagation path; and
deflecting the general optical propagation path of the light beam portions towards a pupil of each user's eye, according to the registration.

12. The method of claim 11, wherein said at least one parameter of the external scene and of said virtual image comprises at least one of position and orientation.

13. The method of claim 11, further comprising transmitting light towards the external scene, collecting light reflected therefrom, and processing the collected light to generate the three dimensional image data thereof.

14. The method of claim 11, wherein said producing of a plurality of light beam portions comprises generating at least one light beam portion at a certain wavelength range.

15. The method of claim 11, wherein said receiving of a light beam portion reflected from the retina comprises performing image scanning such that the reflected light beam portions corresponding to various locations on the retina are sequentially collected.

16. The method of claim 11, wherein said deflecting of the general optical propagation path of the light beam portions towards a pupil of an user's eye comprises at least one of performing image scanning during which the light beam portions are deflected such that the light beam portions are incident on the pupil with various pupil incident angles corresponding to various locations on the retina; or transmitting one or more spectral bands of the light beam portions towards the pupil of the user.

17. The method of claim 11, wherein said receiving a light beam portion reflected from the retina comprises detecting reflection of IR or a visible light beam portion.

18. A registration system to be used with an augmented reality system, the registration system comprising:
a sensor configured and operable for receiving a light beam portion reflected from a retina of a user's eye and imaging the reflected light beam portion being indicative of an image of an external scene perceived by the user's eye to thereby generate a reconstructed image; and
a control unit connected to said sensor and being configured and operable to receive a three dimensional image data of an external scene, compare said reconstructed image with said three dimensional image data; and register between at least one parameter of the external scene and of a virtual image relative to the eye to thereby enable to project said virtual image onto the retina in registration with the external scene.

19. The registration system of claim 18, wherein said at least one parameter of the external scene and of said virtual image comprises at least one of position and orientation.

20. The registration system of claim 18, further comprising at least one of an image generator adapted to obtain data indicative of said virtual image, produce a plurality of light beam portions corresponding to pixels of said virtual image, and direct said light beam portions to propagate along a general optical propagation path; or an eye projection optical module including a deflector, which is configured and operable for deflecting the general optical propagation path of the light beam portions towards a pupil of the user's eye, thereby directly projecting said virtual image onto a retina of the eye or an imaging unit adapted to transmit light towards the external scene, collect light reflected therefrom, and process the collected light to generate a captured three dimensional image thereof.
